(19) United States
(12) Patent Application Publication
(10) Pub. No.: US 2021/0390546 A1
(43) Pub. Date: Dec. 16, 2021

(54) Systems and Methods for Secure Transaction Processing

(71) Applicant: MagTek, Inc., Seal Beach, CA (US)

(72) Inventor: Andrew K. Deignan, Malvern, PA (US)

(73) Assignee: MagTek, Inc., Seal Beach, CA (US)

(21) Appl. No.: 17/348,508

(22) Filed: Jun. 15, 2021

Related U.S. Application Data
(60) Provisional application No. 63/039,396, filed on Jun. 15, 2020.

(51) Int. Cl. G06Q 20/40; G06Q 20/36; G06Q 20/32; G06Q 20/10

(52) U.S. Cl. CPC G06Q 20/409; G06Q 20/102; G06Q 20/3276; G06Q 20/3674

(57) ABSTRACT

Systems and methods for securing transaction processing in accordance with embodiments of the invention are illustrated. One embodiment includes a method for tokenizing transactions. The method includes steps for receiving transaction information from a merchant interface, generating a token associated with the transaction, and transmitting the token to a customer. The method can also include steps for receiving the token from a customer interface, providing a transaction user interface (UI) to the customer interface based on the received token, and receiving and processing payment information for the transaction.

### CROSS REFERENCE TO RELATED APPLICATIONS

This application claims priority to U.S. Provisional Patent Application Ser. No. 63/039,396, filed Jun. 15, 2020, the disclosure of which is herein incorporated by reference in its entirety.

### FIELD OF THE INVENTION

The present invention generally relates to transaction processing and, more specifically, to systems and methods for securing information in processing transactions.

### BACKGROUND

The security of financial and identification information is an important concern for consumers and merchants alike. However, such sensitive information can often be intercepted, whether over a network (e.g., via man-in-the-middle attacks) or at a weak point in the system (e.g., when a merchant's system is hacked or when a dishonest employee steals information). Opportunities for interception can increase in touchless transactions, where the parties are remote from each other (e.g., over the phone, Internet, etc.). It can be desirable to secure such transactions and minimize the exposure of sensitive information.

### SUMMARY OF THE INVENTION

Systems and methods for securing transaction processing in accordance with embodiments of the invention are illustrated. One embodiment includes a method for tokenizing transactions. The method includes steps for receiving transaction information from a merchant interface, generating a token associated with the transaction, and transmitting the token to a customer. The method can also include steps for receiving the token from a customer interface, providing a transaction user interface (UI) to the customer interface based on the received token, and receiving and processing payment information for the transaction.

In a further embodiment, the customer interface is a card reader and the transaction information includes merchant point-of-sale (POS) context information. Providing the transaction UI includes modifying the card reader with the POS context information.

In still another embodiment, transmitting the token to a customer includes providing a link for the customer to a web payment portal, and the link includes the token.

In a still further embodiment, providing the link includes at least one of displaying a QR code at the merchant interface, emailing the link to a customer email, and sending a text message includes the link to a customer phone number.

In yet another embodiment, the method further includes steps for validating the received token prior to providing the transaction UI.

In a yet further embodiment, validating the token includes receiving and validating authentication information for the customer interface, wherein the authentication information includes a serial number associated with the customer interface.

In a yet further embodiment, the token includes merchant credentials. Receiving and processing the payment includes decrypting the token to identify the merchant credentials and communicating with a payment processor using the merchant credentials and the payment information to complete a payment to the merchant.

In a further additional embodiment, the method further includes steps for configuring a card reader to associate a card swipe with the transaction, the customer, and a merchant.

In another embodiment again, the token includes an encrypted portion, metadata, and validation data.

One embodiment includes a non-transitory machine readable medium containing processor instructions for tokenizing transactions, where execution of the instructions by a processor causes the processor to perform a process that comprises receiving transaction information from a merchant interface, generating a token associated with the transaction, transmitting the token to a customer, receiving the token from a customer interface, providing a transaction user interface (UI) to the customer interface based on the received token, and receiving and processing payment information for the transaction.

One embodiment includes a tokenization system comprising a set of one or more processors, and a non-transitory machine readable medium containing processor instructions for tokenizing transactions, where execution of the instructions by the set of processors causes the set of processors to perform a process that comprises receiving transaction information from a merchant interface, generating a token associated with the transaction and the merchant interface, transmitting the token to a personal device associated with the customer, receiving the token from a customer interface, providing a transaction user interface (UI) to the customer interface based on the received token, and receiving and processing payment information for the transaction.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates an example of a transaction system that performs transactions across a network in accordance with an embodiment of the invention.

FIG. 2 illustrates another example of a transaction system that performs transactions in accordance with an embodiment of the invention.

FIG. 3 illustrates an example of a token in accordance with an embodiment of the invention.

FIG. 4 illustrates an example of a tokenization element that can tokenize transactions in accordance with an embodiment of the invention.

FIG. 5 illustrates an example of a tokenization application that can tokenize transactions in accordance with an embodiment of the invention.

FIG. 6 conceptually illustrates an example of a process for tokenizing a transaction in accordance with an embodiment of the invention.

### DETAILED DESCRIPTION

Turning now to the drawings, systems and methods for tokenizing transactions in accordance with numerous embodiments of the invention are described herein. In many cases, transactions will be performed where the physical data card is not present (i.e., card not present (CNP) transactions). CNP transactions can often carry higher expenses for a merchant due to increased risk of fraud or chargebacks. In addition, customers can be wary of sharing their information through out-of-band channels (e.g., over the phone).

Rather than completing a transaction at a merchant, tokenization systems in accordance with several embodiments of the invention can allow merchants to push the transaction to the customer such that the POS is now the cardholder's device. Tokens with a merchant's POS context in accordance with many embodiments of the invention can allow a merchant's POS environment to be pushed to the customer's device, without exposing the merchant's sensitive data to the customer's device.

By tokenizing merchant context data and providing access to a gateway or payment processor directly, tokenization systems in accordance with numerous embodiments of the invention can reduce the exposure of sensitive data (of both the customer and the merchant) between the parties as well as over the networks.

Although many of the examples described herein refer to invoices, one skilled in the art will recognize that similar systems and methods can be used in a variety of transactions without departing from this invention.

### Systems for Tokenizing Transactions

### Tokenization System

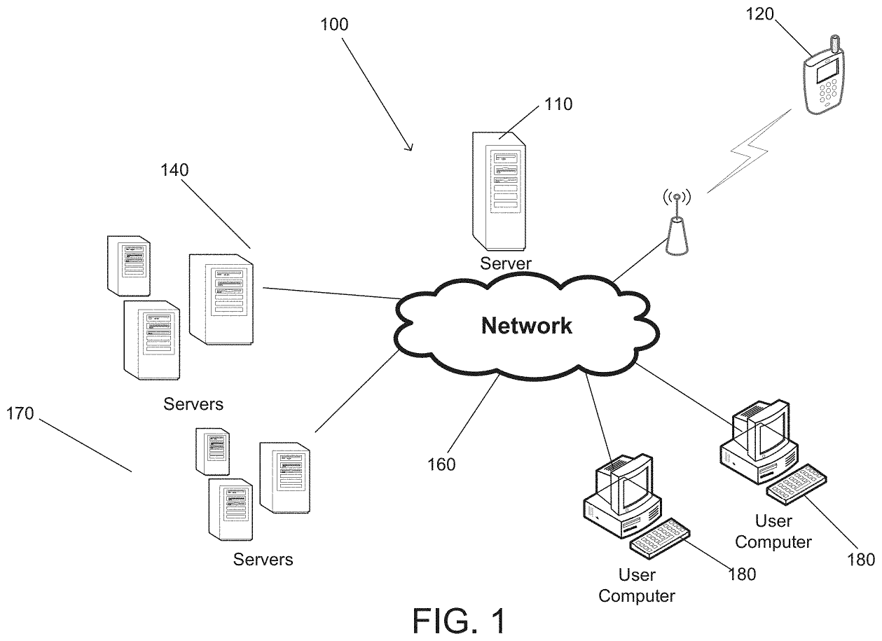

An example of a tokenization system that can tokenize transactions in accordance with some embodiments of the invention is illustrated in FIG. 1. Network 100 includes a communications network 160. The communications network 160 is a network such as the Internet that allows devices connected to the network 160 to communicate with other connected devices. Server systems 110, 140, and 170 are connected to the network 160. Each of the server systems 110, 140, and 170 is a group of one or more servers communicatively connected to one another via internal networks that execute processes that provide cloud services to users over the network 160. Server systems in accordance with several embodiments of the invention can include (but are not limited to) tokenization systems and/or payment processors. One skilled in the art will recognize that a tokenization system may exclude certain components and/or include other components that are omitted for brevity without departing from this invention.

For purposes of this discussion, cloud services are one or more applications that are executed by one or more server systems to provide data and/or executable applications to devices over a network. The server systems 110, 140, and 170 are shown each having three servers in the internal network. However, the server systems 110, 140 and 170 may include any number of servers and any additional number of server systems may be connected to the network 160 to provide cloud services. In accordance with various embodiments of this invention, a tokenization system that uses systems and methods that tokenize transactions in accordance with an embodiment of the invention may be provided by a process being executed on a single server system and/or a group of server systems communicating over network 160.

Users may use personal devices 180 and 120 that connect to the network 160 to perform tokenized transactions in accordance with various embodiments of the invention. In the shown embodiment, the personal devices 180 are shown as desktop computers that are connected via a conventional “wired” connection to the network 160. However, the personal device 180 may be a desktop computer, a laptop computer, point-of-sale (POS) terminal, card reader system, a smart television, an entertainment gaming console, or any other device that connects to the network 160 via a “wired” connection. The mobile device 120 connects to network 160 using a wireless connection. A wireless connection is a connection that uses Radio Frequency (RF) signals, Infrared signals, or any other form of wireless signaling to connect to the network 160. In FIG. 1, the mobile device 120 is a mobile telephone. However, mobile device 120 may be a mobile phone, Personal Digital Assistant (PDA), a tablet, a smartphone, a wireless card reader, or any other type of device that connects to network 160 via wireless connection without departing from this invention.

As can readily be appreciated the specific computing system used to tokenize transactions is largely dependent upon the requirements of a given application and should not be considered as limited to any specific computing system(s) implementation.

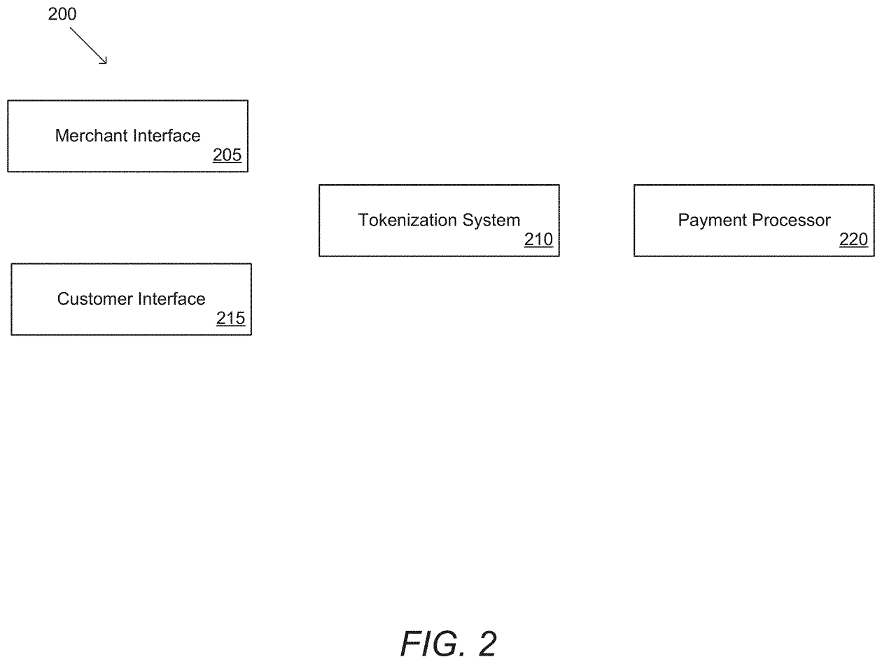

Another example of a tokenization system that can tokenize transactions in accordance with some embodiments of the invention is illustrated in FIG. 2. Transaction system 200 includes merchant interface 205, tokenization system 210, customer interface 215, and payment processor 220. In certain embodiments, merchants can interact with merchant interfaces to initiate a transaction, which can communicate with a tokenization system to tokenize data for the transaction. Tokenized data in accordance with a number of embodiments of the invention can be provided directly to a customer interface, where the customer can complete the payment for a transaction with a payment processor (e.g., via the tokenization system).

Merchant interfaces in accordance with numerous embodiments of the invention can include various devices for initiating merchant transactions, such as (but not limited to) point of sale (POS) terminals, mobile devices, computers, etc. In some embodiments, merchants can interact with merchant interfaces to communicate transaction information to a tokenization system to generate an invoice for a transaction. Transaction information in accordance with a variety of embodiments of the invention can include (but is not limited to) customer information, merchant information, invoice amounts, invoice numbers, descriptions of services/products, etc. In numerous embodiments, tokenization systems can reduce the exposure of merchant interfaces to customer data. As merchant interfaces no longer interact directly with the customer's sensitive information, they can simply provide transaction data and customer data to the tokenization service and wait for confirmation of payment. In many embodiments, the token can be provided to the merchant interface, which can provide and/or coordinate the provision of the token to the customer device.

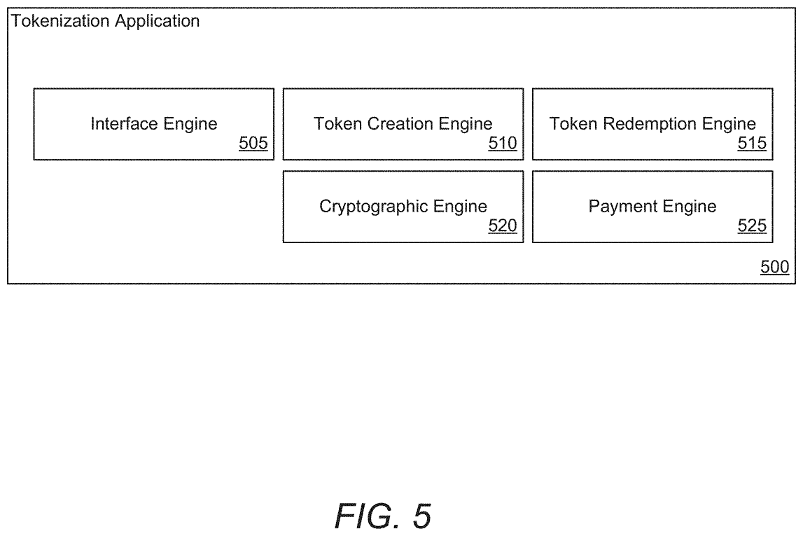

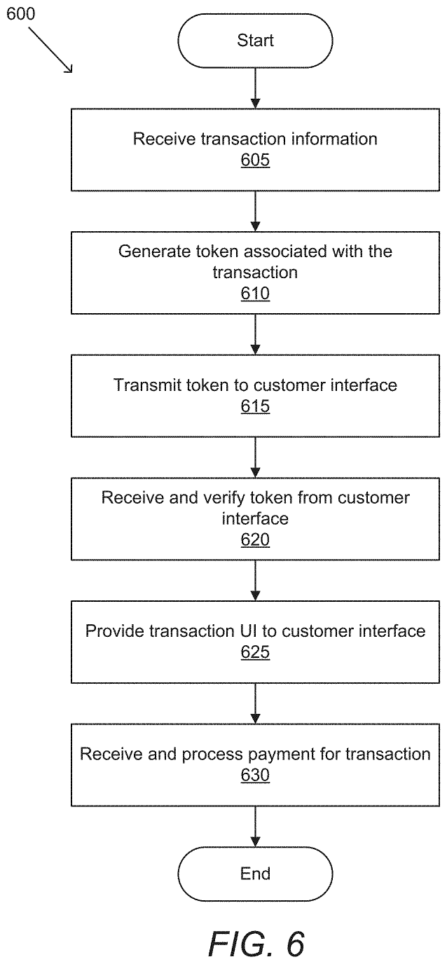

In some embodiments, tokenization systems can be configured to receive transaction data and to tokenize the transaction data. In a variety of embodiments, tokens are at least partially reversible tokens, with encrypted (or otherwise protected) data. In a number of embodiments, each token generated by a tokenization system can be encrypted with a different key. Tokens in accordance with a number of embodiments of the invention can include an encrypted portion (or cryptogram), metadata, and/or validation data (e.g., a hash) that can be used to verify that the token has not been tampered with. Various approaches for tokenization in accordance with many embodiments of the invention are described in greater detail with reference to FIGS. 5 and 6. Tokenization systems in accordance with numerous embodiments of the invention can provide a link (e.g., via a text message, an email, a quick response (QR) code, etc.) with the token to a customer interface. In many embodiments, the token can be provided directly to a customer. Alternatively, or conjunctively, tokenization systems can provide the customer to the merchant, who can then provide the token to the customer.

Customer interfaces in accordance with some embodiments of the invention can allow a customer to complete a transaction with a merchant via a tokenization system. In various embodiments, customer interfaces can include (but are not limited to) mobile phones, card readers, computers, and/or other devices. Customer interfaces in accordance with many embodiments of the invention can receive a token via a link (e.g., from a text message, email, QR code, etc.), that can be used to access a payment interface, and provide payment information to the tokenization system. Payment interfaces in accordance with various embodiments of the invention can include a web payment portal to complete a transaction. In several embodiments, payment information can be provided through a payment service (e.g., APPLE PAY, ANDROID PAY, etc.).

In some embodiments, payment interfaces can include a customer's card reader. Customer interfaces in accordance with a variety of embodiments of the invention can receive a token and allow a user to use (e.g., swipe, tap, insert, virtual transactions, digital wallet payments, etc.) a card at a physical card reader to complete a transaction based on the received token. For example, a customer may have a card reader that is not associated with any particular merchant. When a merchant sends a tokenized invoice to the customer, the user may swipe their physical card in the card reader to send the payment information for the invoice from the merchant. In many embodiments, tokens can be used to configure the card reader to associate a given card swipe with a given invoice and/or merchant. Customer interfaces in accordance with many embodiments of the invention can use tokens to push the merchant's POS environment into the customer interface. Tokens in accordance with numerous embodiments of the invention can be sent with the payment data to the tokenization service, which can redeem the tokenized invoice to associate the payment data with the invoice and/or merchant.

In some embodiments, payment processors can handle transactions for merchants, directing funds between merchants and their customers. Payment processors in accordance with several embodiments of the invention can include various third party companies that communicate with the financial institutions of the customer and merchant to execute transactions. In many embodiments, tokenization systems can provide all of the information from a transaction to a payment processor, without exposing the sensitive data of either party to each other. Payment processors can provide authorization for a transaction to a tokenization system, which can provide receipts, acknowledgements and/or confirmations to merchants and/or clients.

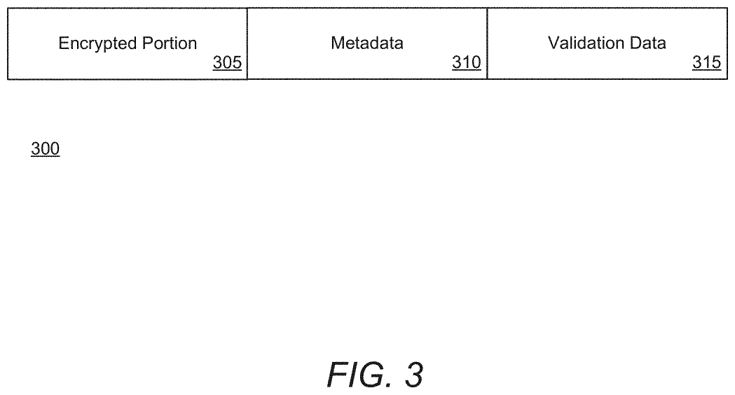

In numerous embodiments, tokens can be used to secure transactions (or invoices) between a merchant and their customers. An example of a token in accordance with an embodiment of the invention is illustrated in FIG. 3. Token 300 includes encrypted portion 305, metadata 310, and validation data 315. In a number of embodiments, tokens can include encrypted and non-encrypted portions.

Encrypted portions in accordance with several embodiments of the invention can be used to protect sensitive data from being viewed by unauthorized parties. In several embodiments, data from encrypted portions can include (but is not limited to) point of sale (POS) context data, merchant data, customer data, device data, card data, and/or encryption key data. POS context data in accordance with various embodiments of the invention can include (but is not limited to) an amount of the transaction, business rules surrounding the transaction (e.g., whether to include a tip, a time period during which the transaction can be completed, etc.), and/or a transaction type. Business rules in a token in accordance with some embodiments of the invention can be used to verify that a payment for a given transaction meets the requirements of the other party (e.g., the merchant) in the transaction.

In a number of embodiments, authentication data (e.g., merchant credentials, customer IDs, device IDs, serial numbers, card data, encryption key data, etc.) can be included in the token. Authentication data in accordance with various embodiments of the invention can include merchant credentials and/or card identification data (e.g., MAGNEPRINT data) to authenticate the card to be used in a transaction.

In many embodiments, metadata of a token can include data that describes the token and/or the encrypted portions of the data. Metadata in accordance with many embodiments of the invention can be unencrypted to allow a customer (or their device) to read the information without access to the cryptographic keys. In a number of embodiments, metadata can include (but is not limited to) format data for the encrypted data, description of the transaction, userID, the last four numbers of the user's credit card to be used in the transaction, etc.

Although metadata can be available without encryption, metadata in accordance with a number of embodiments of the invention can be protected from tampering or modification using validation data, such as through the use of a one-way function (such as hashing). Validation data in accordance with several embodiments of the invention can be used to validate that data in the token has not been modified.

While specific implementations of tokens have been described above, there are numerous configurations of tokens, including, but not limited to, those using more or fewer sections, and/or any other configuration as appropriate to the requirements of a given application.

### Tokenization Element

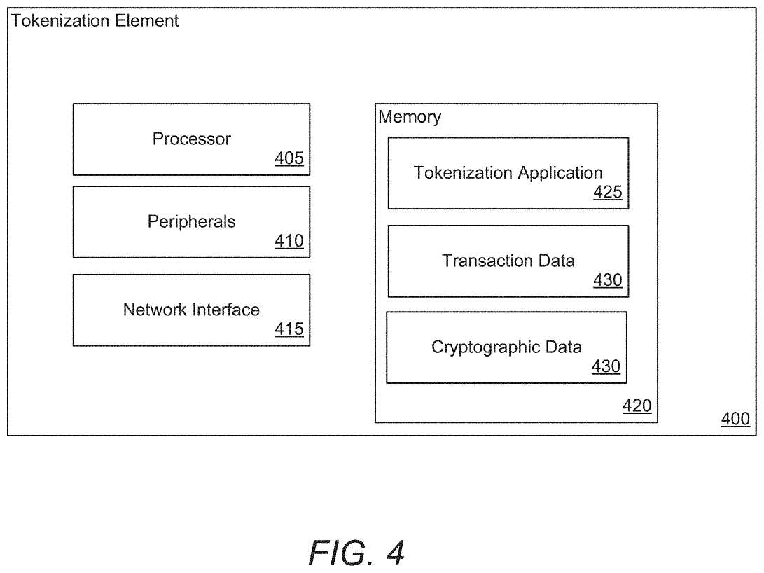

An example of a tokenization element that executes instructions to perform processes that tokenize transactions in accordance with various embodiments of the invention is illustrated in FIG. 4. Tokenization elements in accordance with many embodiments of the invention can include (but are not limited to) one or more of mobile devices, card readers, and/or computers. Tokenization element 400 includes processor 405, peripherals 410, network interface 415, and memory 420. One skilled in the art will recognize that a tokenization element may exclude certain components and/or include other components that are omitted for brevity without departing from this invention.

The processor 405 can include (but is not limited to) a processor, microprocessor, controller, or a combination of processors, microprocessor, and/or controllers that performs instructions stored in the memory 420 to manipulate data stored in the memory. Processor instructions can configure the processor 405 to perform processes in accordance with certain embodiments of the invention.

Peripherals 410 can include any of a variety of components for capturing data, such as (but not limited to) cameras, card readers, payment processing devices, magnetic stripe readers, displays, and/or sensors. In a variety of embodiments, peripherals can be used to gather inputs and/or provide outputs. Tokenization element 400 can utilize network interface 415 to transmit and receive data over a network based upon the instructions performed by processor 405. Peripherals and/or network interfaces in accordance with many embodiments of the invention can be used to gather inputs that can be used to tokenize transactions.

Memory 420 includes a tokenization application 425, transaction data 430, and cryptographic data 435. Tokenization applications in accordance with several embodiments of the invention can be used to tokenize transactions. In several embodiments, transaction data includes data received from merchants that is to be tokenized and provided to a customer. Cryptographic data in accordance with some embodiments of the invention can include cryptographic keys for encrypting and decrypting the tokens through a tokenized transaction process in accordance with many embodiments of the invention.

Although a specific example of a tokenization element 400 is illustrated in FIG. 4, any of a variety of tokenization elements can be utilized to perform processes for tokenizing transactions similar to those described herein as appropriate to the requirements of specific applications in accordance with embodiments of the invention.

### Tokenization Application

An example of a tokenization application in accordance with an embodiment of the invention is illustrated in FIG. 5. Tokenization application 500 includes customer interface engine 505, token creation engine 510, token redemption engine 515, cryptographic engine 520, and payment engine 525. One skilled in the art will recognize that a tokenization application may exclude certain components and/or include other components that are omitted for brevity without departing from this invention.

Interface engines in accordance with many embodiments of the invention can provide user interfaces to merchants and/or clients. User interfaces in accordance with numerous embodiments of the invention can be provided in various formats, such as (but not limited to) through a desktop application, a web application, text messages, etc. In a number of embodiments, interface engines can provide application programming interfaces (APIs) that can allow third-party applications to programmatically access a tokenization application to generate and/or redeem tokens.

In a variety of embodiments, token creation engines can generate tokens for a given transaction. Tokens in accordance with various embodiments of the invention can include encrypted data for a transaction. In several embodiments, generating tokens can include (but is not limited to) encrypting data, generating metadata, generating validation data, and/or concatenating data into a single token. Examples of tokens and token data are described with reference to FIG. 3.

Token redemption engines in accordance with a number of embodiments of the invention can redeem tokens that have been generated. Redeeming tokens in accordance with various embodiments of the invention can include (but is not limited to) decrypting the token, parsing decrypted data, and/or validating that a token has not been tampered with. Validating a token in accordance with some embodiments of the invention can include (but is not limited to) verifying a hash, checking for a token expiration date (e.g., included with the token data), etc. In several embodiments, cryptographic engines can be used to encrypt and/or decrypt tokens (or portions of the tokens).

Payment engines in accordance with numerous embodiments of the invention can use customer payment information (e.g., credit card data) to complete the payment for an invoice. In several embodiments, tokenization systems can operate as gateways, where payment engines can communicate with payment processors to complete payments.

Although a specific example of a tokenization application 500 is illustrated in FIG. 5, any of a variety of tokenization applications can be utilized to perform processes for tokenizing transactions similar to those described herein as appropriate to the requirements of specific applications in accordance with embodiments of the invention.

An example of a process for tokenizing a transaction in accordance with an embodiment of the invention is illustrated in FIG. 6. Process 600 receives (605) transaction information. In a variety of embodiments, processes can use the received transaction information to generate an invoice. In a variety of embodiments, transaction information may be based on transactions that are negotiated out-of-band (e.g., via person-to-person interactions). Transaction information in accordance with a number of embodiments of the invention can include (but is not limited to) invoice amounts, invoice numbers, customer identification, phone numbers, email, a listing of goods/services, etc.

Process 600 generates (610) a token associated with the transaction. Tokens in accordance with some embodiments of the invention can include invoice and merchant data that can be used to associate payments with the corresponding merchant and invoice. In numerous embodiments, tokens can be generated as a globally unique identifier (GUID). Generating a token in accordance with certain embodiments of the invention can include encrypting at least a portion of the data and/or generating validation data for a portion of the data. Tokens in accordance with numerous embodiments of the invention are described in greater detail herein with reference to FIG. 3.

Process 600 transmits (615) the generated token to a customer interface. Transmitting the generated token in accordance with numerous embodiments of the invention can be done by providing a link (e.g., via text message, email, QR code, etc.) that includes the token within the link. In some embodiments, the customer interface can include a card reader, where tokens can be provided to the card reader to provide the context of a POS system.

Process 600 receives and verifies (620) a token from the customer interface. Verifying tokens in accordance with a number of embodiments of the invention can include determining that the token has not been tampered with. Validating a token in accordance with some embodiments of the invention can include (but is not limited to) verifying a hash, checking for a token expiration date (e.g., included with the token data), etc. In some embodiments, verifying tokens can include decrypting the tokens.

Process 600 provides (625) a transaction user interface (UI) to the customer interface. Transaction UIs in accordance with several embodiments of the invention can include a payment form that allows a user to submit payment information. In various embodiments, transaction UIs can instruct a user to swipe their card in a user's physical card reader. In many embodiments, the transaction UI can be generated based on the contents of the received token.

Process 600 receives and processes (630) payment for the transaction. Processing payment in accordance with various embodiments of the invention can include communicating with a set of one or more payment processors to complete a transaction. Processes in accordance with a variety of embodiments of the invention can use the decrypted data from the token to process the payment. In some embodiments, processes can validate payment information with the token. For example, when business rules for a transaction only allow a user to pay the invoiced amount or to add a tip, the process can reject any transactions that modify the invoiced amount. In certain embodiments, once a payment is processed, processes can provide confirmation to a merchant and/or a customer of whether the transaction was successful. Processes in accordance with numerous embodiments of the invention can provide a receipt to a customer after the transaction is complete.

While specific processes for tokenizing transactions are described above, any of a variety of processes can be utilized to tokenize transactions as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

Although specific methods of tokenization are discussed above, many different methods of tokenization can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for tokenizing transactions, the method comprising:
receiving transaction information from a merchant interface;
generating a token associated with the transaction;
transmitting the token to a customer;
receiving the token from a customer interface;
providing a transaction user interface (UI) to the customer interface based on the received token; and
receiving and processing payment information for the transaction.

2. The method of claim 1, wherein the customer interface is a card reader, the transaction information comprises merchant point-of-sale (POS) context information, and providing the transaction UI comprises modifying the card reader with the POS context information.

3. The method of claim 1, wherein transmitting the token to a customer comprises providing a link for the customer to a web payment portal, wherein the link comprises the token.

4. The method of claim 3, wherein providing the link comprises at least one of displaying a QR code at the merchant interface, emailing the link to a customer email, and sending a text message comprising the link to a customer phone number.

5. The method of claim 1 further comprising validating the received token prior to providing the transaction UI.

6. The method of claim 5, wherein validating the token comprises receiving and validating authentication information for the customer interface, wherein the authentication information comprises a serial number associated with the customer interface.

7. The method of claim 1, wherein the token comprises merchant credentials, wherein receiving and processing the payment comprises:
decrypting the token to identify the merchant credentials; and
communicating with a payment processor using the merchant credentials and the payment information to complete a payment to the merchant.

8. The method of claim 1 further comprising configuring a card reader to associate a card swipe with the transaction, the customer, and a merchant.

9. The method of claim 1, wherein the token comprises an encrypted portion, metadata, and validation data.

10. A non-transitory machine readable medium containing processor instructions for tokenizing transactions, where execution of the instructions by a processor causes the processor to perform a process that comprises:
receiving transaction information from a merchant interface;
generating a token associated with the transaction;
transmitting the token to a customer;
receiving the token from a customer interface;
providing a transaction user interface (UI) to the customer interface based on the received token; and
receiving and processing payment information for the transaction.

11. The non-transitory machine readable medium of claim 10, wherein the customer interface is a card reader, the transaction information comprises merchant point-of-sale (POS) context information, and providing the transaction UI comprises modifying the card reader with the POS context information.

12. The non-transitory machine readable medium of claim 10, wherein transmitting the token to a customer comprises providing a link for the customer to a web payment portal, wherein the link comprises the token.

13. The non-transitory machine readable medium of claim 10, wherein receiving the token comprises receiving authentication information for the customer interface, wherein the authentication information comprises a serial number associated with the customer interface.

14. The non-transitory machine readable medium of claim 10, wherein the token comprises merchant credentials, wherein receiving and processing the payment comprises:
decrypting the token to identify the merchant credentials; and
communicating with a payment processor using the merchant credentials and the payment information to complete a payment to the merchant.

15. A tokenization system comprising:
a set of one or more processors; and
a non-transitory machine readable medium containing processor instructions for tokenizing transactions, where execution of the instructions by the set of processors causes the set of processors to perform a process that comprises:
receiving transaction information from a merchant interface;
generating a token associated with the transaction and the merchant interface;
transmitting the token to a personal device associated with the customer;
receiving the token from a customer interface;
providing a transaction user interface (UI) to the customer interface based on the received token; and
receiving and processing payment information for the transaction.

16. The tokenization system of claim 15, wherein the customer interface is a card reader, the transaction information comprises merchant point-of-sale (POS) context information, and providing the transaction UI comprises modifying the card reader with the POS context information.

17. The tokenization system of claim 15, wherein transmitting the token to a customer comprises providing a link for the customer to a web payment portal, wherein the link comprises the token.

18. The tokenization system of claim 17, wherein providing the link comprises at least one of displaying a QR code at the merchant interface, emailing the link to a customer email, and sending a text message comprising the link to a customer phone number.

19. The tokenization system of claim 15, wherein receiving the token comprises receiving authentication information for the customer interface, wherein the authentication information comprises a serial number associated with the customer interface.

20. The tokenization system of claim 15, wherein the token comprises merchant credentials, wherein receiving and processing the payment comprises:
decrypting the token to identify the merchant credentials; and
communicating with a payment processor using the merchant credentials and the payment information to complete a payment to the merchant.
